(19) United States
(12) Patent Application Publication
(10) Pub. No.: US 2026/0368073 A1
(43) Pub. Date: Nov. 19, 2026

(54) Large Language Model-Based Software Automated Testing Method and System

(71) Applicant: TWAI Inc., Grand Cayman (KY)

(72) Inventor: CHE-MIN CHUNG, Kaohsiung City (TW)

(21) Appl. No.: 19/651,819

(22) Filed: Apr. 20, 2026

Related U.S. Application Data
(60) Provisional application No. 63/790,721, filed on Apr. 18, 2025.

(51) Int. Cl. G06F 11/3668

(52) U.S. Cl. CPC G06F 11/3688; G06F 11/3692

(57) ABSTRACT

A software automated testing method comprises: launching a target application having a user interface and providing a predetermined workflow; executing a test agent program configured to operate in a whitelist mode and/or an exploration mode; executing, in the whitelist mode, the predetermined workflow according to a predetermined flowchart; calling, in the exploration mode, a large language model to understand functions provided by user interface elements on the user interface, and testing the user interface elements to generate test results to construct a test flowchart; comparing the test flowchart with the predetermined flowchart to identify an error occurrence node; and generating, via the large language model, a test report according to the error occurrence node. A system using the above method is also provided.

### CROSS-REFERENCE TO RELATED APPLICATION

This application claims priority to and the benefit of U.S. Provisional Patent Application Ser. No. 63/790,721, filed on Apr. 18, 2025, the entire contents of which are incorporated herein by reference.

### FIELD

The present invention relates to software testing technology, and more particularly, to a software automated testing method and system based on a large language model.

### BACKGROUND

Software testing is an indispensable part of the software development process and is used to ensure the quality and stability of an application before the application is released. Conventional software automated testing is mostly performed by executing pre-written test scripts or recorded operation traces, so as to verify whether the core functions of an application conform to expectations.

However, such conventional testing methods often require a large amount of manpower for writing and maintaining scripts during execution. When the user interface of an application changes, the existing test scripts also need to be adjusted accordingly, resulting in high overall testing costs. Therefore, how to further improve the efficiency of software automated testing is a problem to be solved in this field.

### SUMMARY

In view of the above, the present invention provides a software automated testing method and system based on a large language model, in which a large language model is used to understand functions provided by user interface elements of a user interface of a target application, and the user interface elements are tested to construct a test flowchart. An error occurrence node is then identified by comparing the test flowchart with a predetermined flowchart, and a test report including a design defect analysis is generated via the large language model, so as to solve the above problem.

A first aspect of the present invention provides a software automated testing method based on a large language model, executed by a computing device, and the method comprises: launching a target application, wherein the target application has at least one user interface and is configured to provide at least one predetermined workflow; executing a test agent program, wherein the test agent program is configured to operate in at least one of a whitelist mode and an exploration mode; executing, via the test agent program operating in the whitelist mode, the at least one predetermined workflow on the target application according to a predetermined flowchart; calling, via the test agent program operating in the exploration mode, the large language model to understand a plurality of functions provided by a plurality of user interface elements on the at least one user interface; testing, via the test agent program operating in the exploration mode, the plurality of user interface elements to generate a plurality of test results for the plurality of user interface elements and constructing the plurality of test results into a test flowchart; comparing the test flowchart with the predetermined flowchart to identify at least one error occurrence node; and generating, via the large language model, a test report of at least one design bug present in the target application according to the at least one error occurrence node.

In some embodiments of the first aspect, testing, via the test agent program operating in the exploration mode, the plurality of user interface elements comprises: receiving a target user profile, wherein the target user profile includes at least one of an age group parameter and an education level parameter; and injecting the target user profile into the large language model, such that the large language model simulates a corresponding cognitive limitation and an interface operation preference, so as to determine a click priority order for the plurality of user interface elements in the target application.

In some embodiments of the first aspect, testing, via the test agent program operating in the exploration mode, the plurality of user interface elements comprises: capturing an accessibility label or screen boundary coordinates of the tested plurality of user interface elements; and converting the accessibility label or the screen boundary coordinates into an automated control command, so as to trigger a state change of the target application.

In some embodiments of the first aspect, testing, via the test agent program operating in the exploration mode, the plurality of user interface elements comprises: evaluating, via the large language model, a coverage value of a plurality of candidate operation paths according to the plurality of test results and the plurality of user interface elements on a current screen of the target application; and selecting the candidate operation path having a highest coverage value as a next operation.

In some embodiments of the first aspect, before launching the target application, the method further comprises: receiving a natural language instruction; and performing semantic parsing on the natural language instruction to extract at least one of a test target, a test scope, and a number of test runs and determining, accordingly, the target application to be launched and the at least one predetermined workflow to be executed.

A second aspect of the present invention provides a software automated testing system based on a large language model, the system comprising a memory and a processor. The memory is configured to store at least one instruction, and the processor is coupled to the memory and configured to execute the at least one instruction to: launch a target application, wherein the target application has at least one user interface and is configured to provide at least one predetermined workflow; execute a test agent program, wherein the test agent program is configured to operate in at least one of a whitelist mode and an exploration mode; execute, via the test agent program operating in the whitelist mode, the at least one predetermined workflow on the target application according to a predetermined flowchart; call, via the test agent program operating in the exploration mode, the large language model to understand a plurality of functions provided by a plurality of user interface elements on the at least one user interface; test, via the test agent program operating in the exploration mode, the plurality of user interface elements to generate a plurality of test results for the plurality of user interface elements and construct the plurality of test results into a test flowchart; compare the test flowchart with the predetermined flowchart to identify at least one error occurrence node; and generate, via the large language model, a test report of at least one design bug present in the target application, according to the at least one error occurrence node.

In some embodiments of the second aspect, testing, via the test agent program operating in the exploration mode, the plurality of user interface elements comprises: receiving a target user profile, wherein the target user profile includes at least one of an age group parameter and an education level parameter; and injecting the target user profile into the large language model, such that the large language model simulates a corresponding cognitive limitation and an interface operation preference, so as to determine a click priority order for the plurality of user interface elements in the target application.

In some embodiments of the second aspect, testing, via the test agent program operating in the exploration mode, the plurality of user interface elements comprises: capturing an accessibility label or screen boundary coordinates of the tested plurality of user interface elements; and converting the accessibility label or the screen boundary coordinates into an automated control command, so as to trigger a state change of the target application.

In some embodiments of the second aspect, testing, via the test agent program operating in the exploration mode, the plurality of user interface elements comprises: evaluating, via the large language model, a coverage value of a plurality of candidate operation paths according to the plurality of test results and the plurality of user interface elements on a current screen of the target application; and selecting the candidate operation path having a highest coverage value as a next operation.

In some embodiments of the second aspect, before launching the target application, the processor is further configured to execute the at least one instruction to: receive a natural language instruction; and perform semantic parsing on the natural language instruction to extract at least one of a test target, a test scope, and a number of test runs and determine, accordingly, the target application to be launched and the at least one predetermined workflow to be executed.

### BRIEF DESCRIPTION OF THE DRAWINGS

FIG. 1 is a flowchart illustrating steps of a software automated testing method based on a large language model according to an embodiment of the present invention;

FIG. 2 is a schematic diagram of a checkout page of a shopping application according to an embodiment of the present invention;

FIG. 3 is a schematic block diagram of a computing system according to an embodiment of the present invention.

### DETAILED DESCRIPTION OF PREFERRED EMBODIMENTS

Reference will now be made in detail to embodiments of the present invention, illustrating a method and system for converting voice data into an executable workflow, in which identical components are denoted by identical reference numerals.

The following description contains specific information related to exemplary embodiments of the present invention. The drawings in the present invention and the accompanying detailed description are merely exemplary embodiments. However, the present invention is not limited to these exemplary embodiments. Other variations and embodiments of the present invention will occur to those skilled in the art. Unless otherwise specified, identical or corresponding elements in the drawings may be indicated by identical or corresponding reference numerals. In addition, the drawings and illustrations in the present invention are generally not drawn to scale and are not intended to correspond to actual relative dimensions.

For purposes of consistency and ease of understanding, identical features are indicated by reference numerals in the exemplary drawings (although this may not be the case in some examples). However, features in different embodiments may differ in other respects, and therefore should not be narrowly limited to the features shown in the drawings.

Terms such as “at least one embodiment,” “an embodiment,” “various embodiments,” “different embodiments,” “some embodiments,” “the present embodiment,” and the like may indicate that the embodiment(s) of the present invention so described may include a particular feature, structure, or characteristic, but not every possible embodiment of the present invention necessarily includes the particular feature, structure, or characteristic. In addition, repeated use of the phrases “in an embodiment” and “in the present embodiment” does not necessarily refer to the same embodiment, although they may. Furthermore, phrases such as “embodiment” used in connection with “the present invention” do not imply that all embodiments of the present invention must include the particular feature, structure, or characteristic, and should be understood as “at least some embodiments of the present invention” including the particular feature, structure, or characteristic described. The term “coupled” is defined as connected, whether directly or indirectly through intervening elements, and is not necessarily limited to a physical connection. When the term “comprising” is used, it means “including but not limited to,” which expressly indicates an open-ended inclusion or relationship of the stated combination, group, series, and equivalents.

In addition, for purposes of explanation and not limitation, specific details such as functional entities, techniques, protocols, standards, and the like are set forth to provide an understanding of the described technology. In other instances, detailed descriptions of well-known methods, techniques, systems, architectures, and the like are omitted to avoid unnecessarily obscuring the description.

The terms “first,” “second,” and “third” used in the specification of the present invention and the above drawings are used to distinguish different objects and are not used to describe a particular order. In addition, the term “comprising” and its variants are intended to cover a non-exclusive inclusion. For example, a process, method, system, product, or device that includes a series of steps or modules is not limited to the listed steps or modules, but may optionally further include steps or modules not listed, or may optionally further include other steps or modules inherent to such process, method, product, or device.

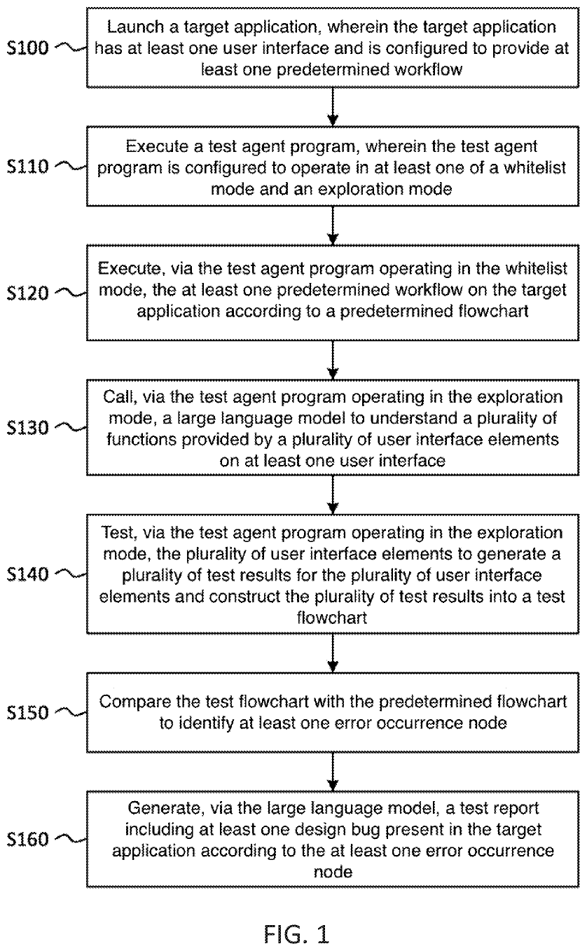

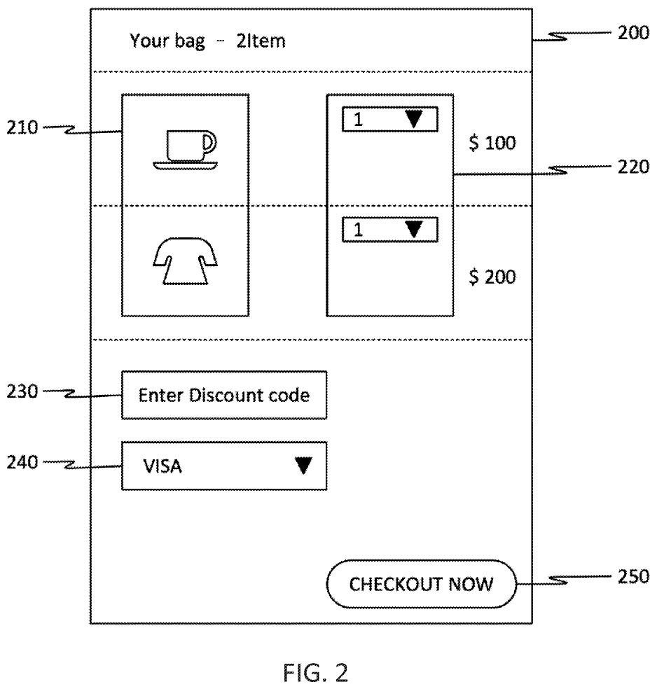

FIG. 1 is a flowchart illustrating the steps of a software automated testing method based on a large language model according to an embodiment of the present invention. FIG. 2 is a schematic diagram of a checkout page of a shopping application according to an embodiment of the present invention.

Referring to FIG. 1 and FIG. 2, the method of the present embodiment may be executed by a computing device, and the computing device includes a memory and a processor (described in subsequent drawings). The method understands, via a large language model, the functions provided by user interface elements of a target application and performs automated testing on the user interface elements to construct a test flowchart. An error occurrence node is identified by comparing the test flowchart with a predetermined flowchart, and a test report including a design defect is generated via the large language model. The steps shown in FIG. 1 are described one by one below, using a checkout page 200 of a shopping application shown in FIG. 2 as an embodiment of the target application.

In step S100, the computing device launches a target application, wherein the target application has at least one user interface and is configured to provide at least one predetermined workflow. Specifically, the target application may be any software application having a user interface, such as a desktop application, a mobile device application, or a web application, and the present invention is not limited thereto. The user interface of the target application provides an operating interface for a user to interact with the target application and is configured to provide at least one predetermined workflow for the user to complete a specific operation objective.

For example, as shown in FIG. 2, the target application may be a shopping application, and the user interface of the shopping application may be a checkout page 200. The checkout page 200 includes a plurality of user interface elements, including a product list 210, a quantity adjustment button 220, a promo code input field 230, a payment method menu 240, and a checkout button 250. The predetermined workflow provided by the checkout page 200 may be a “complete product checkout” workflow, which sequentially includes the operation steps of viewing the products in the product list 210, adjusting the quantity of a product via the quantity adjustment button 220, entering a promo code in the promo code input field 230, selecting a payment method in the payment method menu 240, and clicking the checkout button 250 to complete checkout.

In some embodiments, before launching the target application, the computing device may further perform a preliminary step of receiving a test instruction. Specifically, the computing device may receive a natural language instruction and perform semantic parsing on the natural language instruction to extract at least one of a test target, a test scope, and a number of test runs, and determine, accordingly, the target application to be launched and the at least one predetermined workflow to be executed.

For example, when the computing device receives a natural language instruction from a user of “please perform one thousand automated tests on the checkout workflow of the shopping application,” the computing device may extract, through semantic parsing, the test target as “checkout workflow,” the test scope as “shopping application,” and the number of test runs as “one thousand,” and accordingly determine that the target application to be launched is the shopping application and the predetermined workflow to be executed is the “complete product checkout” workflow. Advantageously, by receiving and semantically parsing the natural language instruction, a user can define a test task without a programmatic configuration, thereby lowering the technical threshold for a tester to perform automated testing.

In step S110, the computing device executes a test agent program, wherein the test agent program is configured to operate in at least one of a whitelist mode and an exploration mode. Specifically, the test agent program is a software program executed by a processor of the computing device, for performing testing operations on the target application in place of a human. The test agent program may operate in the whitelist mode, the exploration mode, or a combination of both modes, according to testing requirements.

In detail, the whitelist mode is used to execute a predefined core workflow to verify whether the core functions of the target application conform to expectations. The exploration mode is used to test the behavior of the user interface elements of the target application under unexpected operating scenarios, so as to discover edge cases not covered by the predefined workflow. In some embodiments, the test agent program may operate in the whitelist mode and the exploration mode simultaneously to execute both modes of testing in parallel, so as to balance verification of the stability of the core functions with improvement of the coverage of edge cases. Advantageously, through the flexible combination of the whitelist mode and the exploration mode, the present invention can provide a corresponding testing strategy according to the testing requirements of different stages (such as regression testing, stress testing, or exploratory testing), thereby improving the adaptability and coverage of software automated testing.

For example, when the test agent program operates in the whitelist mode and the exploration mode simultaneously, the computing device may start at least two threads via the processor, wherein a first thread executes the test agent program operating in the whitelist mode, so as to sequentially execute, on the checkout page 200 of the shopping application, the predetermined workflow of “viewing the product list 210→adjusting the product quantity→entering the promo code→selecting the payment method→clicking the checkout button 250” according to the predetermined flowchart, so as to verify the stability of the core checkout function. A second thread simultaneously executes the test agent program operating in the exploration mode, so as to test each user interface element on the checkout page 200, such as entering a special character into the promo code input field 230, adjusting the product quantity to zero or a negative number via the quantity adjustment button 220, or rapidly switching payment methods in the payment method menu 240.

In some embodiments, the test agent program operating in the whitelist mode and the test agent program operating in the exploration mode may share screen information and operating status of the target application, so that the test results of both modes may be cross-referenced. Advantageously, through parallel execution of the whitelist mode and the exploration mode, the present invention can simultaneously verify the core function stability of the target application and explore edge cases in the same testing process, which, compared to sequentially executing both modes of testing, can shorten the overall testing time and improve testing coverage.

In step S120, the computing device executes, via the test agent program operating in the whitelist mode, the at least one predetermined workflow on the target application according to a predetermined flowchart. Specifically, the predetermined flowchart is a flowchart pre-constructed according to the predetermined workflow of the target application, which represents, by a plurality of state nodes and at least one action edge, the sequential order of each operation step in the predetermined workflow and the corresponding user interface state. The test agent program operating in the whitelist mode sequentially executes, on the target application, the corresponding operations according to the operation steps defined in the predetermined flowchart.

For example, corresponding to the predetermined workflow of the checkout page 200 shown in FIG. 2, the predetermined flowchart may sequentially include the state nodes of “viewing the product list,” “adjusting the product quantity,” “entering the promo code,” “selecting the payment method,” and “clicking the checkout button.” The test agent program operating in the whitelist mode sequentially performs, according to the predetermined flowchart, the corresponding operations on the product list 210, the quantity adjustment button 220, the promo code input field 230, the payment method menu 240, and the checkout button 250, so as to verify whether each core step of the checkout workflow can be executed normally. In some embodiments, the test agent program may, during execution of the whitelist mode, simultaneously record the execution result of each state node, for use as reference data for subsequently generating the test report.

In step S130, the computing device calls, via the test agent program operating in the exploration mode, a large language model to understand a plurality of functions provided by a plurality of user interface elements on at least one user interface. Specifically, the test agent program operating in the exploration mode transmits screen information of a current user interface of the target application to the large language model, and the large language model, by analyzing the screen information, understands the functions provided by each user interface element on the screen, for use as a basis for subsequent testing operations.

In detail, the large language model is a natural language processing model based on a deep learning architecture, which, through pre-training on a large-scale corpus, has the capability to understand the semantics, grammar, and contextual context of natural language. In some embodiments, the large language model may adopt a model based on a Transformer architecture, such as a model of the GPT series, the LLaMA series, the Gemini series, or the Claude series. Those of ordinary skill in the art should understand that the large language model used in the present invention is not limited to the specific models described above, and any model capable of performing semantic understanding of user interface elements may be applied in the present invention. Advantageously, by adopting a large language model having semantic understanding capability, the present invention can automatically identify and understand the functions provided by each user interface element without predefining identification rules for the user interface elements for each target application, thereby improving the versatility of the present invention across different target applications.

For example, when the test agent program operating in the exploration mode transmits the screen information of the checkout page 200 shown in FIG. 2 to the large language model, the large language model may understand that the product list 210 is “a list presenting the products that have been added to the shopping cart,” the quantity adjustment button 220 is “an increase/decrease control element for adjusting the product quantity,” the promo code input field 230 is “a text input field for a user to enter a discount code,” the checkout button 250 is “a trigger button for confirming an order and entering the payment process,” and the payment method menu 240 is “a drop-down menu for a user to select a payment method.”

In some embodiments, when calling the large language model to understand the functions of the user interface elements, the computing device may further receive a target user profile and inject the target user profile into the large language model, such that the large language model simulates a corresponding cognitive limitation and an interface operation preference, so as to determine a click priority order for the user interface elements in the target application. The target user profile includes at least one of an age group parameter and an education level parameter.

For example, when the target user profile is “age group: 65 years or older with education level: junior high school,” the large language model may simulate the cognitive limitations of such a user (such as a lower ability to understand English-language buttons and a lower familiarity with complex operating procedures) and interface operation preferences (such as a tendency to click one item at a time rather than use swipe gestures), and accordingly adjust the click priority order of the user interface elements, such that the test agent program preferentially tests the user interface elements most likely to be encountered as difficult to operate by such a user, for example, preferentially testing the promo code input field 230 (because the English-language prompt text may cause confusion) or the payment method menu 240 (because the numerous options may cause difficulty in selection). As another example, when the target user profile is “age group: 18 to 25 years old with education level: college or above,” the large language model may simulate the operating habits of such a user (such as a preference for swipe gestures and a habit of skipping instructional text) and accordingly adjust the click priority order such that the test agent program preferentially tests errors that may occur in a quick-operation scenario. Advantageously, by injecting the target user profile, the present invention can perform differentiated automated testing for the cognitive differences and operating habits of different user groups, so as to discover group-specific operational problems that cannot be covered by conventional random testing, thereby improving the breadth and depth of test coverage.

In some embodiments, when the test agent program operating in the exploration mode calls the large language model to understand the functions of the user interface elements, a screen screenshot of the target application and structured information of the user interface elements may be packaged into a prompt instruction, and the prompt instruction may be transmitted to the large language model. The structured information of the user interface elements may include information such as a component type, an attribute parameter, a text label, a hierarchical relationship, or a relative position of each user interface element.

For example, when the test agent program operating in the exploration mode calls the large language model with respect to the checkout page 200 shown in FIG. 2, the test agent program may package, into the prompt instruction, the screen screenshot of the checkout page 200 together with structured information such as a Document Object Model (DOM) tree, a view hierarchy, or a component attribute list including the checkout page 200. After receiving the prompt instruction, the large language model returns a structured result (for example, data presented in JSON format) including an identifier and a corresponding function description of each user interface element, for use by the test agent program to perform subsequent testing operations. Advantageously, by packaging the screen screenshot together with the structured information into the prompt instruction, the present invention enables the large language model to perform multimodal semantic understanding by referring to both visual information and structural information simultaneously, thereby improving the accuracy and reliability of identifying the function of the user interface elements.

In step S140, the computing device tests, via the test agent program operating in the exploration mode, the plurality of user interface elements to generate a plurality of test results for the plurality of user interface elements and constructs the plurality of test results into a test flowchart. Specifically, the test agent program operating in the exploration mode performs testing operations on the user interface elements according to the functions of the user interface elements understood via the large language model in step S130 and records the test result of each testing operation, so as to construct the test results into a test flowchart and present the state nodes and operation paths actually experienced during the testing process.

In some embodiments, when testing the user interface elements, the computing device may capture the accessibility label or screen boundary coordinates of the tested user interface elements and convert the accessibility label or the screen boundary coordinates into an automated control command, so as to trigger a state change of the target application. The accessibility label is a text description set by an application developer for each user interface element, for assisting a visually impaired user in understanding the function of each user interface element through an assistive tool. The screen boundary coordinates are a pixel range occupied by a user interface element on the screen.

For example, when the test agent program is to test the checkout button 250 shown in FIG. 2, the test agent program may capture the accessibility label of the checkout button 250 (for example, “Checkout”) or the screen boundary coordinates (for example, X:300, Y:800, width: 120, height: 48), and convert the accessibility label or the screen boundary coordinates into a corresponding automated control command, such as an “adb tap 360 824” command of an Android operating system or an “XCUIElement.tap( )” command of an iOS testing framework, so as to simulate a user's operation of clicking the checkout button 250, thereby triggering a state change of the target application. Advantageously, by capturing the accessibility label or the screen boundary coordinates and converting the same into an automated control command, the present invention can directly operate the user interface elements of the target application without relying on the source code or internal interface of the target application, allowing the present invention to be widely applied to various types of target applications.

In some embodiments, when testing the user interface elements in the exploration mode, the computing device may further evaluate, via the large language model, a coverage value of a plurality of candidate operation paths according to the test results and the user interface elements on a current screen of the target application and select the candidate operation path having the highest coverage value as a next operation. The coverage value is a quantitative indicator for evaluating the degree of contribution of the candidate operation path to increasing the test coverage.

For example, after the test agent program has tested the operation path of “viewing the product list 210→clicking the checkout button 250,” the large language model may evaluate the coverage value of the remaining candidate operation paths on the current screen of the target application. For example, the candidate operation path of “entering an invalid promo code into the promo code input field 230→clicking the checkout button 250” has a higher coverage value because it involves untested promo code validation logic, and the candidate operation path of “adjusting the product quantity to zero via the quantity adjustment button 220→clicking the checkout button 250” also has a higher coverage value because it involves untested quantity boundary logic. The large language model accordingly selects the candidate operation path having the highest coverage value as the next operation, so as to maximize the test coverage. Advantageously, through the coverage value evaluation via the large language model, the present invention can intelligently explore test paths within a limited number of test runs, and, compared to the blind operation of conventional random testing, can more efficiently discover design bugs hidden in the target application.

In some embodiments, when the computing device captures the accessibility label or the screen boundary coordinates of the user interface elements, various technical means may be used to accommodate different types of target applications. For example, when the target application is a mobile application of the Android operating system, the computing device may capture information such as the accessibility label, the component type, and the screen boundary coordinates of each user interface element through an accessibility service (AccessibilityService) interface provided by the Android operating system; when the target application is a mobile application of the iOS operating system, the computing device may capture corresponding information through a UI accessibility (UIAccessibility) interface provided by the iOS operating system; when the target application is a web application, the computing device may obtain the document object model tree of the webpage and the attribute and position information of each webpage element through a browser automation framework (such as Selenium, Playwright, or Puppeteer); when the target application is a desktop application, the computing device may analyze a screen screenshot of the target application through an image recognition technique to identify the type and position of each user interface element. Advantageously, through the flexible combination of the above various technical means, the present invention can be widely applied to different types of target applications, such as mobile applications, web applications, and desktop applications, thereby improving the cross-platform applicability of the present invention.

In step S150, the computing device compares the test flowchart with the predetermined flowchart to identify at least one error occurrence node. Specifically, the computing device compares the test flowchart constructed in step S140 with the predetermined flowchart on which step S120 is based, so as to identify an operation trajectory in the test flowchart that deviates from the predetermined flowchart, and to mark the point of deviation as the error occurrence node.

For example, when the expected state of the predetermined flowchart after clicking the checkout button 250 is “entering a payment confirmation page,” and the test flowchart shows that the actual state entered after clicking the checkout button 250 is “an error message window pops up,” the computing device may determine that this node is the error occurrence node. In some embodiments, when performing the comparison, the computing device may sequentially and synchronously traverse the plurality of state nodes of the test flowchart and the predetermined flowchart starting from an initial node and calculate an interface structure similarity between the test flowchart and the predetermined flowchart at the corresponding nodes. When the interface structure similarity is lower than a predetermined threshold, the computing device may mark the current node in the test flowchart as the error occurrence node.

In some embodiments, when the computing device performs the comparison between the test flowchart and the predetermined flowchart, the comparison may be performed by the test agent program operating in a debug mode. Specifically, in addition to operating in the whitelist mode and the exploration mode, the test agent program may further operate in the debug mode. The test agent program operating in the debug mode receives the test flowchart constructed in step S140 and the predetermined flowchart on which step S120 is based, and performs a sequential comparison according to the state nodes of the two flowcharts, so as to identify the error occurrence node in the test flowchart that deviates from the predetermined flowchart. In some embodiments, the computing device may also perform the comparison between the test flowchart and the predetermined flowchart through a debug program independent of the test agent program, and the present invention is not limited thereto. Advantageously, by making the comparison operation independent as the debug mode or an independent debug program, the present invention can decouple test execution from comparison analysis, thereby improving the modularity and maintenance flexibility of the system.

In some embodiments, the computing device may, upon detecting a test anomaly, trigger a flow difference comparison between the test flowchart and the predetermined flowchart, so as to reduce the consumption of computing resources. Specifically, the computing device continuously monitors the execution state of the target application during the process of the test agent program executing the test, and upon detecting a test anomaly, the computing device triggers the flow difference comparison to identify the error occurrence node.

For example, the test anomaly may include a scenario in which the target application crashes, the user interface of the target application becomes unresponsive (not responding), the target application pops up an unexpected error message window, or the target application enters an unexpected user interface state. When the computing device detects any of the above test anomalies, the computing device may immediately capture the current test flowchart and perform the flow difference comparison with the predetermined flowchart, so as to rapidly locate the error occurrence node. Advantageously, by triggering the flow difference comparison only upon detecting a test anomaly, the present invention can avoid the waste of computing resources caused by continuously performing the comparison operation during the testing process, while ensuring that diagnostic analysis can be performed immediately when a test anomaly occurs.

In step S160, the computing device generates, via the large language model, a test report including at least one design bug present in the target application according to the at least one error occurrence node. Specifically, the computing device transmits information such as the user interface element, the operation trajectory, and the error screen corresponding to the error occurrence node to the large language model, and the large language model analyzes, according to such information, a design bug present in the target application, and generates a test report including the design bug analysis.

In some embodiments, when generating the test report, the computing device may perform, via the large language model, an analysis of the design bug by combining the user interface element corresponding to the error occurrence node with a screenshot of the error screen. Specifically, upon detecting a test anomaly, the computing device captures a screenshot of the current error screen of the target application, and transmits the error screen screenshot together with feature information of the user interface element corresponding to the error occurrence node (such as the accessibility label, the screen boundary coordinates, and the current state) to the large language model, and the large language model performs a multimodal analysis combining text information and screen information, so as to identify the specific manifestation and potential root cause of the design bug.

For example, when the error occurrence node is “an error message window pops up after entering an expired promo code into the promo code input field 230 and clicking the checkout button 250, but the entered promo code is not cleared,” the large language model may analyze, according to the information related to this error occurrence node, that the design bug is “the state of the promo code input field 230 is not reset after the promo code validation fails, which may cause the user to repeatedly trigger the same error,” and accordingly generate a test report including a technical description, reproduction steps, and correction suggestions for this design bug. Advantageously, through the semantic analysis of the error occurrence node via the large language model, the test report generated by the present invention can directly present the design bug present in the target application and its correction direction, allowing a tester to grasp the quality problem of the target application without having to interpret the raw error log, thereby improving the efficiency of defect analysis after testing.

In some embodiments, the test report generated by the computing device may further include a failure root cause summary, which is a human-readable text description generated via the large language model according to the analysis result of the error occurrence node, for explaining the root cause of the design bug and a possible correction direction. Specifically, after analyzing the design bug, the large language model further summarizes the technical aspect involved in the design bug (such as front-end display logic, back-end validation rules, a state management mechanism, or event listener binding) and generates the failure root cause summary in a structured textual form, as part of the test report.

For example, for the aforementioned design bug of “the state of the promo code input field 230 is not reset after the promo code validation fails,” the failure root cause summary generated via the large language model may be: “Root cause level: front-end state management; root cause: the value of the promo code input field 230 is not reset in the callback function of the validation failure event; scope of impact: subsequent operations by the user within the same page; correction suggestion: add logic to clear the value of the promo code input field 230 in the callback function of the validation failure event.” Advantageously, by generating the failure root cause summary, the test report can be directly provided to a software developer as a reference for defect correction, extending the application scope of the present invention to the software defect management process, thereby improving the overall efficiency of a software development team.

In some embodiments, the test report generated by the computing device may further include fields such as a list of design bugs, reproduction steps for each design bug, a corresponding error screen screenshot, related user interface element features, a severity classification, and a correction suggestion. The severity classification may be generated via the large language model after evaluation according to the scope of impact of the design bug on user operation, the frequency of occurrence, and the possible degree of damage, for example, classified into three levels: high, medium, and low.

In some embodiments, the output format of the test report generated by the computing device may include HTML, PDF, Markdown, or a structured data format (such as JSON or XML), and the present invention is not limited thereto.

In some embodiments, the computing device may further automatically create a corresponding defect ticket in a defect tracking system according to the design bug information in the test report. Specifically, the computing device may, through an application programming interface provided by the defect tracking system, use information such as the description, reproduction steps, error screen screenshot, severity classification, and correction suggestion of the design bug as field content of the defect ticket, and assign a corresponding responsible person and a handling deadline.

For example, the computing device may, through an application programming interface provided by a defect tracking system (such as Jira, Redmine, GitHub Issues, or Asana), automatically create the aforementioned design bug of “the state of the promo code input field 230 is not reset after the promo code validation fails” as a defect ticket, and assign it to a corresponding responsible person of the front-end engineering team according to the severity classification. Advantageously, through the mechanism of automatically creating a defect ticket in the defect tracking system, the present invention enables the test results to be seamlessly integrated into the software defect management process, without requiring a tester to manually create a defect ticket one by one after testing is completed, thereby reducing the manpower cost of a software development team in defect management, and further extending the application scope of the present invention to the entire software development life cycle.

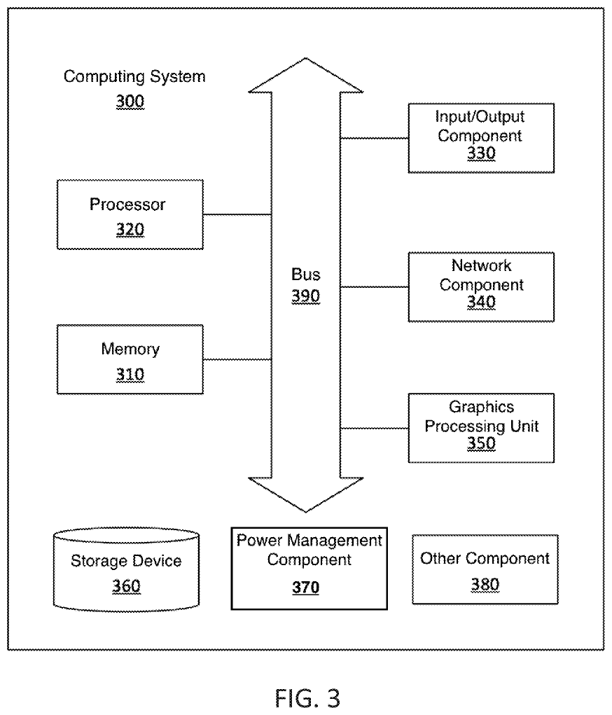

FIG. 3 is a schematic block diagram of a computing system according to an embodiment of the present invention.

Referring to FIG. 3, the software automated testing method based on a large language model described herein is a computer-implemented method, which may be implemented on a computing system 300 having a plurality of hardware components. Similarly, the software automated testing system based on a large language model described herein is also computer-implemented and may likewise be implemented on a computing system 300 having a plurality of hardware components. In some embodiments, the computing system 300 may be implemented, for example, in the form of an electronic device, including, but not limited to, one or more of the following components: a memory 310, a central processing unit (CPU) 320, an input/output component 330, a network component 340, and a graphics processing unit (GPU) 350, wherein these components may communicate and transfer data via a system bus 390. However, the present invention does not limit the specific model, quantity, and configuration of each component, and a person of ordinary skill in the art may adjust, select, or add or remove components according to the specific requirements and operating environment when implementing the present invention.

In some embodiments, the main computing core within the computing system 300 is one or more processors 320. The processor 320 may be responsible for the main computing process and related control logic of algorithms such as running the test agent program, large language model inference, user interface element function understanding, test result analysis, test flowchart construction, and test report generation. In some embodiments, the processor 320 is configured to execute processing instructions (i.e., machine-executable instructions) stored in a non-volatile computer-readable medium (for example, a storage device 360).

In some embodiments, data such as the user interface screen information of the target application, the accessibility labels and screen boundary coordinates of the user interface elements, the test results generated by the test agent program, the test flowchart, and the predetermined flowchart may be stored in the storage device 360, as intermediate processing results between the various processing stages.

In some embodiments, to improve the computational efficiency of large language model inference, the computing system 300 may further include one or more graphics processors 350 specifically designed for performing large-scale parallel computation. The graphics processor 350 can effectively improve the computing capability of the system when the large language model performs function understanding, coverage value evaluation, and design bug analysis on the user interface elements.

In some embodiments, the computing system 300 may implement a batch processing mechanism to simultaneously perform automated testing on a plurality of target applications, thereby improving overall testing efficiency. For example, the processor 320 may, through a parallel computing technique, start a plurality of threads, wherein each thread executes a test agent program to test one target application, and the graphics processor 350 is utilized to accelerate the inference computation of the large language model.

In some embodiments, the computing system 300 may include various input/output components 330 for receiving user input and displaying system output. For example, the input/output component 330 may include a microphone, a keyboard, a mouse, a touchpad, a display screen, a speaker, and other types of sensing devices. In some embodiments, the computing system 300 may receive a natural language instruction from a user through the input/output component 330 or present the test report generated by the present invention through the display screen.

In some embodiments, the computing system 300 may also include a network component 340 for network communication. For example, the network component 340 may include a network interface card for a wired or wireless network connection, or a communication module for 3G, 4G, 5G, or other wireless communication technology. In some embodiments, the computing system 300 may call an external large language model application programming interface through the network component 340 or obtain a target application located on a remote server for performing automated testing.

In some embodiments, the computing system 300 includes one or more memory components 310, such as a volatile memory component, for example, a random access memory (RAM). The memory 310 stores data and programs for executing algorithms such as running the test agent program, large language model inference, and test flowchart construction.

In addition, the computing system 300 may further include one or more of the following components: a storage device 360, a power management component 370, and other components 380 (for example, other hardware components).

In some embodiments, the computing system 300 may include one or more storage devices 360, such as a non-volatile memory component, for example, a hard disk drive (HDD) or a solid-state drive (SSD). These storage devices 360 may be used to store information such as the program code of the software automated testing system based on a large language model, the large language model parameters, and the test agent program parameters. In addition, the storage device 360 may also be used to store intermediate results and final outputs such as the target application screen information, the test results, the test flowchart, the predetermined flowchart, and the test report.

In some embodiments, the computing system 300 may include one or more power management components 370 for supplying power to and managing the power consumption of the various hardware components of the computing system 300. The power management component 370 may include a battery, a power converter, and other power management devices.

In some embodiments, the computing system 300 may further include other components 380, such as a cooling fan, a heat sink, and other various control and monitoring devices, and the present invention is not limited thereto.

In some embodiments, the software automated testing system based on a large language model may be implemented by a variety of hardware architectures. Specifically, the system may be regarded as a functional entity including hardware components such as the memory 310, the processor 320, the input/output component 330, the network component 340, and the storage device 360, which implements core functions such as launching a target application, executing a test agent program, operating the test agent program in at least one of a whitelist mode and an exploration mode, calling a large language model to understand functions of user interface elements, testing the user interface elements to generate test results and construct a test flowchart, comparing the test flowchart with a predetermined flowchart to identify an error occurrence node, and generating a test report of a design bug via the large language model.

In detail, the processor 320 is configured to execute program instructions stored in the memory 310, and the instructions include: code instructing the processor 320 to launch a target application; code instructing the processor 320 to execute a test agent program, so that the test agent program operates in at least one of a whitelist mode and an exploration mode; code instructing the processor 320 to execute, via the test agent program operating in the whitelist mode, a predetermined workflow on the target application according to a predetermined flowchart; code instructing the processor 320 to call, via the test agent program operating in the exploration mode, a large language model to understand functions of user interface elements and test the user interface elements to construct a test flowchart; code instructing the processor 320 to compare the test flowchart with the predetermined flowchart to identify an error occurrence node; and code instructing the processor 320 to generate, via the large language model, a test report of a design bug according to the error occurrence node.

It should be noted that the system of the present invention includes hardware components such as the memory 310, the processor 320, and the input/output component 330. The test agent program and the large language model are stored in the memory 310 or the storage device 360 of the system in the form of program code and parameters and are loaded and executed by the processor 320. That is, the system does not directly include the test agent program and the large language model as hardware components, but rather calls and runs these modules by executing the program code stored in the memory 310, so as to implement the aforementioned method steps. It should be understood that the specific technical details of the above system implementation have been described in detail in the preceding method description of this specification. The system implementation of the present invention is closely related to the method implementation, and the function of each module of the system corresponds to each step of the method. For example, the module for launching the target application in the system corresponds to step S100, the module for executing the test agent program corresponds to step S110, the module for executing the predetermined workflow via the test agent program operating in the whitelist mode corresponds to step S120, the module for calling the large language model to understand the function of the user interface elements via the test agent program operating in the exploration mode corresponds to step S130, the module for testing the user interface elements and constructing the test flowchart corresponds to step S140, the module for comparing the test flowchart with the predetermined flowchart corresponds to step S150, and the module for generating the test report of the design bug corresponds to step S160. Since the specific implementation of these steps has been described in detail in the preceding part of this specification, a person of ordinary skill in the art should be able to understand the specific implementation of the corresponding system, and further description thereof is omitted here.

In summary, the software automated testing method and system based on a large language model provided by the present invention understands, through a large language model, the functions provided by the user interface elements of a target application, and performs automated testing on the target application through a test agent program operating in at least one of a whitelist mode and an exploration mode, so as to construct a test flowchart and compare it with a predetermined flowchart to identify an error occurrence node, and finally generate, via the large language model, a test report including a design bug analysis. Thereby, the present invention can reduce the cost of writing and maintaining conventional automated testing scripts, improve the test coverage and the ability to discover edge cases, and allow a tester to grasp the quality problem of a target application without having to interpret the raw error log, thereby comprehensively improving the efficiency and quality of software automated testing.

Based on the above description, it is apparent that various techniques may be used to implement the concepts described in the present application without departing from the scope of these concepts. In addition, although the concepts have been described with specific reference to certain embodiments, a person of ordinary skill in the art will recognize that changes may be made in form and detail without departing from the scope of these concepts. As such, the described embodiments are to be considered in all respects as illustrative and not restrictive. Moreover, it should be understood that the present application is not limited to the specific embodiments described above, but that many rearrangements, modifications, and substitutions may be made without departing from the scope of the present invention.

What is claimed is:

1. A software automated testing method based on a large language model, executed by a computing device, the method comprising:
launching a target application, wherein the target application has at least one user interface and is configured to provide at least one predetermined workflow;
executing a test agent program, wherein the test agent program is configured to operate in at least one of a whitelist mode and an exploration mode;
executing, via the test agent program operating in the whitelist mode, the at least one predetermined workflow on the target application according to a predetermined flowchart;
calling, via the test agent program operating in the exploration mode, the large language model to understand a plurality of functions provided by a plurality of user interface elements on the at least one user interface;
testing, via the test agent program operating in the exploration mode, the plurality of user interface elements to generate a plurality of test results for the plurality of user interface elements and constructing the plurality of test results into a test flowchart;
comparing the test flowchart with the predetermined flowchart to identify at least one error occurrence node; and
generating, via the large language model, a test report of at least one design bug present in the target application according to the at least one error occurrence node.

2. The method of claim 1, wherein testing, via the test agent program operating in the exploration mode, the plurality of user interface elements comprises:
receiving a target user profile, wherein the target user profile includes at least one of an age group parameter and an education level parameter; and
injecting the target user profile into the large language model, such that the large language model simulates a corresponding cognitive limitation and an interface operation preference, so as to determine a click priority order for the plurality of user interface elements in the target application.

3. The method of claim 1, wherein testing, via the test agent program operating in the exploration mode, the plurality of user interface elements comprises:
capturing an accessibility label or screen boundary coordinates of the tested plurality of user interface elements; and
converting the accessibility label or the screen boundary coordinates into an automated control command, so as to trigger a state change of the target application.

4. The method of claim 1, wherein testing, via the test agent program operating in the exploration mode, the plurality of user interface elements comprises:
evaluating, via the large language model, a coverage value of a plurality of candidate operation paths according to the plurality of test results and the plurality of user interface elements on a current screen of the target application; and
selecting the candidate operation path having a highest coverage value as a next operation.

5. The method of claim 1, wherein, before launching the target application, the method further comprises:
receiving a natural language instruction; and
performing semantic parsing on the natural language instruction to extract at least one of a test target, a test scope, and a number of test runs and determining, accordingly, the target application to be launched and the at least one predetermined workflow to be executed.

6. A software automated testing system based on a large language model, the system comprising:
a memory configured to store at least one instruction; and
a processor coupled to the memory and configured to execute the at least one instruction to:
launch a target application, wherein the target application has at least one user interface and is configured to provide at least one predetermined workflow;
execute a test agent program, wherein the test agent program is configured to operate in at least one of a whitelist mode and an exploration mode;
execute, via the test agent program operating in the whitelist mode, the at least one predetermined workflow on the target application according to a predetermined flowchart;
call, via the test agent program operating in the exploration mode, the large language model to understand a plurality of functions provided by a plurality of user interface elements on the at least one user interface;
test, via the test agent program operating in the exploration mode, the plurality of user interface elements to generate a plurality of test results for the plurality of user interface elements and construct the plurality of test results into a test flowchart;
compare the test flowchart with the predetermined flowchart to identify at least one error occurrence node; and
generate, via the large language model, a test report of at least one design bug present in the target application, according to the at least one error occurrence node.

7. The system of claim 6, wherein testing, via the test agent program operating in the exploration mode, the plurality of user interface elements comprises:
receiving a target user profile, wherein the target user profile includes at least one of an age group parameter and an education level parameter; and
injecting the target user profile into the large language model, such that the large language model simulates a corresponding cognitive limitation and an interface operation preference, so as to determine a click priority order for the plurality of user interface elements in the target application.

8. The system of claim 6, wherein testing, via the test agent program operating in the exploration mode, the plurality of user interface elements comprises:
capturing an accessibility label or screen boundary coordinates of the tested plurality of user interface elements; and
converting the accessibility label or the screen boundary coordinates into an automated control command, so as to trigger a state change of the target application.

9. The system of claim 6, wherein testing, via the test agent program operating in the exploration mode, the plurality of user interface elements comprises:
evaluating, via the large language model, a coverage value of a plurality of candidate operation paths according to the plurality of test results and the plurality of user interface elements on a current screen of the target application; and
selecting the candidate operation path having a highest coverage value as a next operation.

10. The system of claim 6, wherein, before launching the target application, the processor is further configured to execute the at least one instruction to:
receive a natural language instruction; and
perform semantic parsing on the natural language instruction to extract at least one of a test target, a test scope, and a number of test runs and determine, accordingly, the target application to be launched and the at least one predetermined workflow to be executed.
